(19) United States
(12) Patent Application Publication
(10) Pub. No.: US 2004/0224720 A1
(43) Pub. Date: Nov. 11, 2004

(54) Transceiver for locator

(76) Inventors: Huei-Hsin Sun, Taipei City (TW); Yu-Yu Chuang, Banchiau City (TW)

Correspondence Address: Alan D. Kamrath, Rider Bennett, LLP, Suite 2000, 333 South Seventh Street, Minneapolis, MN, 55402, US

(21) Appl. No.: 10/430,935

(22) Filed: May 7, 2003

(51) Int. Cl. H04Q 7/20

(52) U.S. Cl. 455/556.1; 455/90.1; 455/66.1; 455/456.3; 455/404.1

(57) ABSTRACT

A transceiver as a locator mounted in a device (e.g., watch or bracelet) worn on the wrist of, for example, an elderly person is disclosed. The device comprises an antenna assembly including a plurality of antenna elements, the antenna elements being spaced apart and electrically coupled together. The transceiver comprises circuit means adapted to transmit or receive RF signals to or from a cell-site or a satellite based GPS through the antenna assembly for calling for help in case of emergency.

### BACKGROUND OF THE INVENTION

1. Field of the Invention

The present invention relates to transceivers and more particularly to a transceiver mounted in a locator worn by an elderly person. The locator is operative to transmit help signals through the transceiver in case of emergency.

2. Description of Related Art

A conventional locator as a means of calling for help is shown in FIGS. 4 and 5. The locator is mounted in a watch 80. The locator comprises a stabilization circuit 10, a primary processor 20, a secondary processor 30, a memory 40, a voltage detector 50, a high frequency signal transmission circuit 60, and an interface circuit 70. Also, four buttons 801, 802, 803, and 804 are provided at four corners of the rectangular watch 80. The buttons 802, 803, and 804 are data input buttons. Also, a person may press the buttons 801 and 802 for timer setting or battery low test. Most importantly, a person (e.g., elderly person) may press the buttons 801 and 802 to transmit help signals in case of emergency. However, the prior locator suffered from several disadvantages. For example, a circuitry thereof is costly to manufacture. Also, a malfunction of the locator and/or the watch 80 may compromise the desired functions of serving as a means of calling for help and as a timepiece since the locator and the watch 80 are formed integrally. In other words, a malfunction of either the locator or the watch 80 may force a user to discard the whole device. This is not cost effective. Further, it may discourage many potential buyers. Hence, a need for improvement exists.

### SUMMARY OF THE INVENTION

It is an object of the present invention to provide a transceiver as a locator. The transceiver is mounted in a watch. The device comprises an antenna assembly including a plurality of antenna elements, the antenna elements being spaced apart and electrically coupled together. The transceiver comprises circuit means adapted to transmit or receive RF signals to or from a cell-site through the antenna assembly for calling for help.

It is another object of the present invention to provide a transceiver as a locator. The transceiver is mounted in a bracelet. The device comprises an antenna assembly including a plurality of antenna elements, the antenna elements being spaced apart and electrically coupled together. The transceiver comprises circuit means adapted to transmit or receive RF signals to or from a GPS through the antenna assembly for calling for help.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of transceiver as a locator mounted in a band antenna according to the invention;

FIG. 2 is a perspective view of a second preferred embodiment of transceiver as a locator mounted in a watch according to the invention;

FIG. 3 is a perspective view of a third preferred embodiment of transceiver as a locator mounted in a bracelet according to the invention;

FIG. 4 is a perspective view of a conventional locator mounted in a watch; and

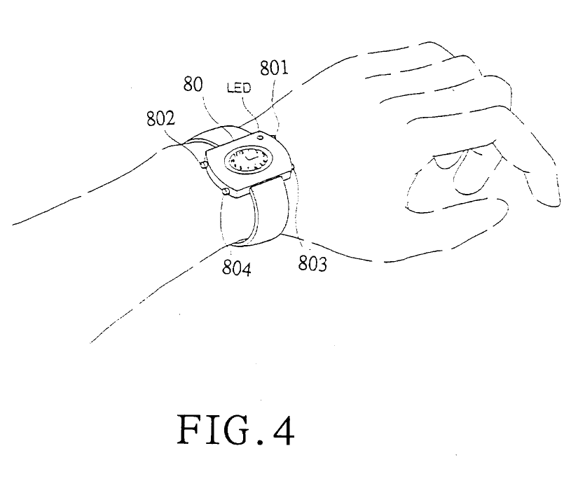

FIG. 5 is a block diagram of circuitry of the conventional locator.

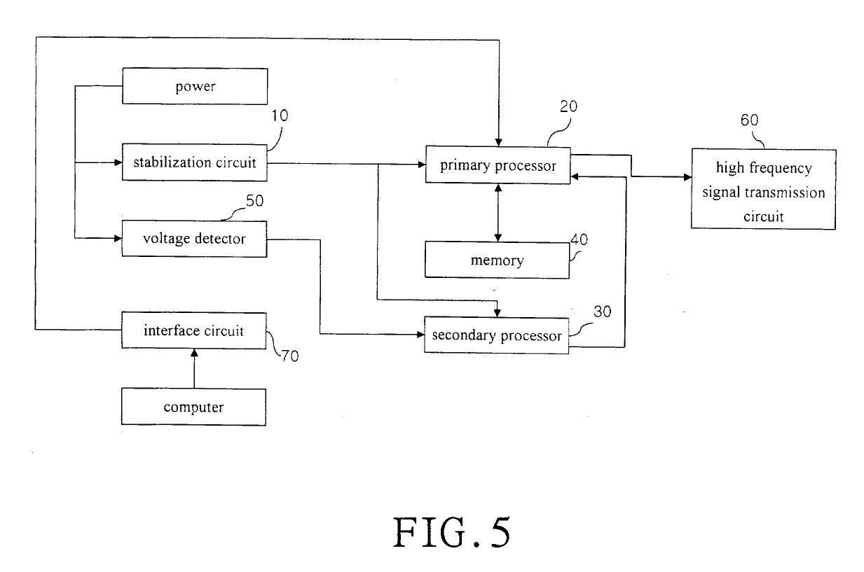

### DETAILED DESCRIPTION OF THE PREFERRED EMBODIMENTS

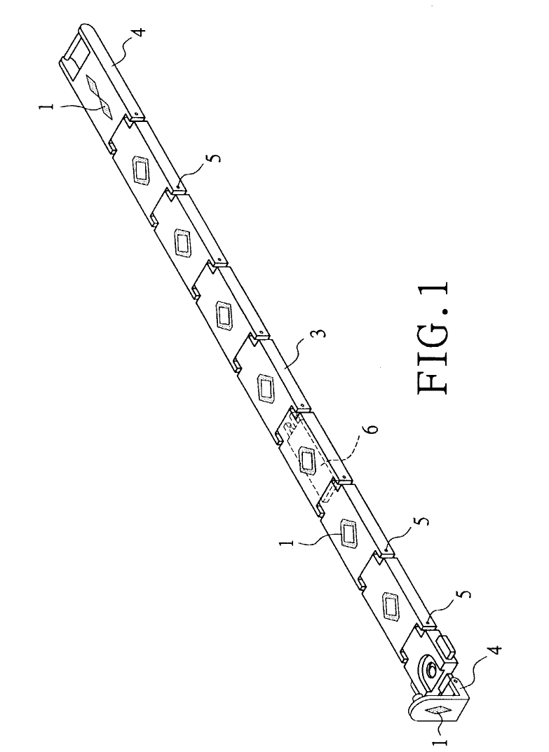

Referring to FIG. 1, there is shown a first preferred embodiment of transceiver 6 in accordance with the invention. The transceiver 6 is adapted to transmit or receive RF (radio frequency) signals to or from a cell-site or a satellite based GPS (Global Positioning System) through an antenna assembly when subjected to pressure or triggered by a button. Hence, the transceiver 6 can be used as a locator as detailed in the following embodiments. As shown, the antenna assembly comprises a plurality of patch antenna elements 1 mounted on a band. Each antenna element 1 is disposed in one of plurality of links 3 of the band or either one of two snapping members 4 at ends of the band. The antenna elements 1 are electrically coupled together by a wire (not shown) through a plurality of hinges 5 each between two adjacent links 3 or between the link 3 and the snapping member 4. Moreover, the transceiver 6 is mounted in one of the links 3. But this embodiment is not used independently. Preferably, this embodiment is incorporated as a component of a watch as detailed below.

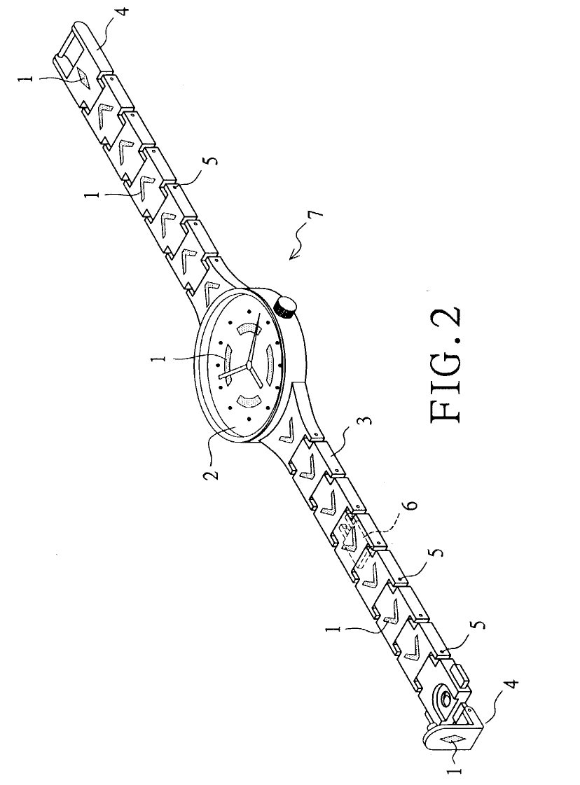

Referring to FIG. 2, there is shown a second preferred embodiment of transceiver 6 in accordance with the invention. As shown, an antenna assembly comprises a plurality of patch antenna elements 1 disposed in a watch 7 in which each antenna element 1 is disposed in a dial surface 2, one of a plurality of links 3 of a watch band, or either one of two end snapping members 4 of the watch band. Also, these antenna elements 1 are electrically coupled together by a wire (not shown) through a plurality of hinges 5 each between two adjacent links 3 or between the link 3 and the snapping member 4. Moreover, the transceiver 6 is mounted in one of the links 3. In case of emergency a person, for example, an elderly person may press the transceiver 6 to transmit signals through the antenna assembly for calling for help.

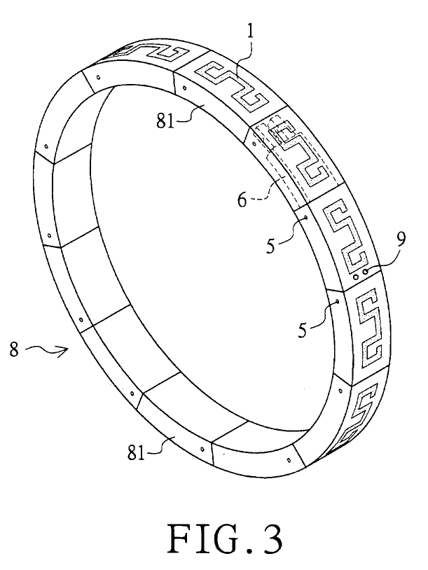

Referring to FIG. 3, there is shown a third preferred embodiment of transceiver 6 in accordance with the invention. As shown, a plurality of antenna elements 1 are spaced apart around a bracelet 8 in which each antenna element 1 is disposed in one of a plurality of links 81 of the bracelet 8. The antenna elements 1 are electrically coupled together by a wire (not shown) through a plurality of hinges 5 each between two adjacent links 81. Moreover, the transceiver 6 is mounted in one of the links 81 and two buttons 9 electrically coupled to the transceiver 6 are mounted on the other link 81. In case of emergency a person, for example, an elderly person may press the buttons 9 to activate the transceiver 6 for transmitting signals through the antenna assembly for calling for help.

In view of the above, the transceiver of the invention can be conveniently used in a personal article such as watch or bracelet.

A RF transmission of the transceiver of the invention may be carried out in one of GSM, CDMA200, or WCDMA as summarized in the following table:

| | GSM | | | CDMA2000 | | WCDMA |
|---|---|---|---|---|---|---|
| parameters | GSM | DCS | PCS | CELL | PCS | EUROPE |
| Forward | 935-960 | 1805-1910 | 1930-1990 | 869-894 | 1930-1990 | 2110-2170 |
| link | | | | | | |
| (MSRX) | | | | | | |
| (MHz) | | | | | | |
| Forward | 890-915 | 1710-1785 | 1850-1910 | 924-849 | 1850-1910 | 1920-1980 |
| link | | | | | | |
| (MSRX) | | | | | | |
| (MHz) | | | | | | |

In addition, the transceiver of the invention can also be carried out in any of other transmissions such as bluetooth (2.4 GHz), WLAN (2.4 GHz), HF, VHF (e.g., FM or DAB), S-band, C-band (e.g., WLAN 802.11.a), X-band, a combination thereof, or a combination of any of the above other transmissions with one of GSM, CDMA200, and WCDMA.

While the invention herein disclosed has been described by means of specific embodiments, numerous modifications and variations could be made thereto by those skilled in the art without departing from the scope and spirit of the invention set forth in the claims.

What is claimed is:

1. A transceiver mounted in a device worn on the wrist, the device including an antenna assembly including a plurality of antenna elements, the antenna elements being spaced apart and electrically coupled together, comprising:
circuit means adapted to transmit or receive RF (radio frequency) signals to or from a cell-site through the antenna assembly for calling for help.

2. The transceiver of claim 1, wherein the device is a watch.

3. A transceiver mounted in a device worn on the wrist, the device including an antenna assembly including a plurality of antenna elements, the antenna elements being spaced apart and electrically coupled together, comprising:
circuit means adapted to transmit or receive RF (radio frequency) signals to or from a GPS (Global Positioning System) through the antenna assembly for calling for help.

4. The transceiver of claim 3, wherein the device is a bracelet.
